(19) United States
(12) Patent Application Publication
(10) Pub. No.: US 2026/0358856 A1
(43) Pub. Date: Nov. 12, 2026

(54) HANDLE ASSEMBLY FOR SPATIAL COMPUTING DEVICES

(71) Applicant: Astra Tech, LLC, Bellevue, WA (US)

(72) Inventors: Danila Ditrikh LIPATS, Bellevue, WA (US); Eric Michael KLEIN, Clinton, WA (US)

(73) Assignee: Astra Tech, LLC, Bellevue, WA (US)

(21) Appl. No.: 19/669,847

(22) Filed: May 6, 2026

Related U.S. Application Data
(60) Provisional application No. 63/802,284, filed on May 8, 2025.

(51) Int. Cl. G06F 1/16; F16M 11/04; F16M 11/14; F16M 13/04

(52) U.S. Cl. CPC G06F 1/163; F16M 11/041; F16M 11/14; F16M 13/04

(57) ABSTRACT

A handle assembly for a head-mounted electronic spatial computing device may include a handle mount having a device coupling interface adapted to releasably engage a complementary structure of the electronic spatial computing device, and a handle arm rotatably coupled to the handle mount. The handle arm may include a handle body defining a grip portion sized to be grasped by a user's hand. The handle arm may be rotatable on the handle mount to change an angular orientation of the handle body relative to the device coupling interface. The handle assembly may permit the user to support, manipulate, or otherwise interact with the electronic spatial computing device through the grip portion.

### CROSS-REFERENCE TO RELATED APPLICATIONS

This application claims the benefit of priority to U.S. Provisional Patent Application No. 63/802,284, filed on May 8, 2025, and titled “Multi-Functional Handle for Virtual Reality, Augmented Reality, Mixed Reality, and Spatial Computing Devices,” the entire disclosure of which is hereby incorporated by reference herein for all purposes.

### TECHNICAL FIELD

This description relates to user interface accessories and components for spatial computing devices, and more specifically to handle assemblies that mechanically engage a head-mounted spatial computing device and provide a user-graspable structure for supporting, manipulating, augmenting, or otherwise interacting with the head-mounted spatial computing device.

### BACKGROUND

Head-mounted spatial computing devices, including virtual reality (VR), augmented reality (AR), mixed reality (MR), and other spatial computing systems, are deployed across consumer entertainment, professional training, education, healthcare, industrial design, and remote collaboration applications. Such devices may include a forward-facing display assembly, a facial interface, on-board sensors and processors, and one or more retention members configured to maintain the device on the head of a wearer. Power for such devices may be supplied by an internal battery, a tethered cable, an external power source, or by a battery pack mounted to a head strap or other retention structure. Some such devices are paired with one or more handheld controllers operable by a user to provide input to the device.

### SUMMARY

In some embodiments, a handle assembly for a head-mounted electronic spatial computing device may include a handle mount configured to be coupled with the head-mounted electronic spatial computing device, a handle arm extending from the handle mount, and a grip portion coupled with the handle arm and configured to be grasped by a user. The grip portion may include or define a handle body and, in some examples, a handle cap. The handle assembly may be configured such that the grip portion is rotatable, relative to the handle mount, about an axis. In some examples, the axis extends along a length of the handle arm. In some examples, the grip portion is rotatable through a continuous range of angular positions, while in other examples the grip portion is indexable between two or more discrete angular positions. Such an arrangement may permit the user to support, manipulate, or otherwise reposition the head-mounted electronic spatial computing device through grasping and rotating the grip portion without releasing the user's grasp.

In some embodiments, a handle assembly for a head-mounted electronic spatial computing device may include a handle mount configured to be coupled with the head-mounted electronic spatial computing device, a handle mounting arm coupled with the handle mount, a ball joint coupled with the handle mounting arm, and a grip portion coupled with the ball joint. The ball joint may permit the grip portion to pivot, relative to the handle mount, about a plurality of non-parallel axes. In some examples, the ball joint includes a ball and a corresponding socket that retains the ball through a range of angular positions. In some examples, the ball joint is selectively lockable to retain the grip portion at a selected angular position relative to the handle mounting arm. Such an arrangement may permit the user to position the grip portion at a comfortable orientation for the user's hand and arm while continuing to support the head-mounted electronic spatial computing device.

In some embodiments, a handle assembly for a head-mounted electronic spatial computing device may include a handle body sized and shaped to resemble at least a portion of a handheld controller for the head-mounted electronic spatial computing device, a coupler extending from the handle body and configured to mechanically engage the head-mounted electronic spatial computing device, and a grip portion coupled with the handle body and offset from the coupler. The handle body may include one or more user-actuatable inputs, such as one or more buttons, one or more triggers, one or more touch-sensitive surfaces, or a combination thereof. The handle assembly may be configured such that the handle body is selectively detachable from the head-mounted electronic spatial computing device and operable as a handheld controller for the head-mounted electronic spatial computing device. Such an arrangement may permit the user to use a single accessory to physically support the head-mounted electronic spatial computing device when the accessory is engaged with the head-mounted electronic spatial computing device, and to provide handheld input to the head-mounted electronic spatial computing device when the accessory is detached from the head-mounted electronic spatial computing device.

### BRIEF DESCRIPTION OF THE DRAWINGS

FIG. 1 is a perspective view of a head-mounted electronic spatial computing device with a handle assembly coupled thereto in accordance with one or more embodiments of the present description.

FIG. 2 is a perspective view of a head-mounted electronic spatial computing device having a first handle assembly and a second handle assembly coupled to laterally opposite sides thereof, with a handle sleeve disposed about a handle body of the second handle assembly, in accordance with one or more embodiments of the present description.

FIG. 3A is a perspective view of a handle assembly, illustrating a handle body in a first angular orientation relative to a handle mount, in accordance with one or more embodiments of the present description.

FIG. 3B is a perspective view of the handle assembly of FIG. 3A, illustrating the handle body in a second angular orientation relative to the handle mount, in accordance with one or more embodiments of the present description.

FIGS. 4A-4C are perspective views of a handle assembly, illustrating one or more couplers carried by a handle mount and configured to engage a retention portion of a head-mounted electronic spatial computing device, in accordance with one or more embodiments of the present description.

FIG. 5 is a perspective view of a handle assembly, illustrating a first button and a second button disposed on a handle body, in accordance with one or more embodiments of the present description.

FIG. 6A is an exploded perspective view of a handle assembly, illustrating a handle mount, a handle body, and a handle cap separated from one another and an electronic component sized to be received within the handle body, in accordance with one or more embodiments of the present description.

FIG. 6B is a perspective view of a handle assembly, illustrating an example bottom of the handle body, in accordance with one or more embodiments of the present description.

FIG. 7 is a perspective view of a handle assembly engaged with a charging stand, in accordance with one or more embodiments of the present description.

FIG. 8 is a perspective view of a handle assembly including a ball joint disposed between a handle mount and a handle mounting arm that supports a handle body, in accordance with one or more embodiments of the present description.

FIG. 9 is a perspective view of a controller adapter embodiment of a handle assembly, illustrating a handle body shaped to releasably engage a handheld controller and a handle mounting arm coupled with the handle body, in accordance with one or more embodiments of the present description.

### DETAILED DESCRIPTION

Reference will now be made in detail to representative embodiments illustrated in the accompanying drawings. The following description is not intended to limit the embodiments to any one of the disclosed embodiments, and is intended to cover alternatives, modifications, and equivalents within the scope of the described embodiments as defined by the appended claims. The handle assemblies described herein may be supplied as accessories for retrofitting onto an existing head-mounted electronic spatial computing device, integrated with such a device at the time of manufacture, or configured to operate as a handheld controller when detached. Features described with respect to one embodiment may be combined with, substituted for, or omitted from features described with respect to any other embodiment, except where context dictates otherwise.

As used herein, the term “head-mounted electronic spatial computing device” refers broadly to head-wearable computing devices that present visual or audiovisual content to a wearer, including without limitation virtual reality (VR) headsets, augmented reality (AR) headsets, mixed reality (MR) headsets, extended reality (XR) headsets, smart glasses, head-mounted displays (HMDs), and other devices having a display assembly configured to be supported in front of one or both eyes of a wearer. Such devices may include any combination of optical assemblies, display assemblies, on-board image-capture assemblies, depth sensors, inertial measurement units, eye-tracking systems, audio transducers, processors, memory, wireless radios, batteries, retention members, and facial interfaces. Embodiments of the handle assemblies described herein may be used with any such device, regardless of the particular sensor, optical, or display configuration.

Existing approaches to physically interacting with head-mounted electronic spatial computing devices may, in some circumstances, present opportunities for improvement. Such devices are typically retained on the head of a wearer through one or more straps that bear against the wearer's forehead, crown, and skull, and donning and doffing the device by manipulating the straps may involve the use of two hands, disturb the wearer's hair, and apply compressive forces against the wearer's skull while seating the device. Some wearers may find such procedures cumbersome, particularly in use cases involving short-duration immersive demonstrations, retail sampling, or public installations, where the wearer may prefer simply to hold the device against the face. Holding the device against the face by grasping its housing, however, may obstruct sensors of the device, impart fingerprints or oils onto optical elements or housing surfaces, and present an unstable grasp.

Certain head-mounted electronic spatial computing devices are paired with one or more handheld controllers, and the wearer may experience a need to support the device with one hand while operating a controller with the other hand, or to set the device down without a clearly identified resting surface in order to free both hands. Head-mounted electronic spatial computing devices are also commonly shared among multiple users in retail showrooms, location-based entertainment venues, training facilities, healthcare environments, and educational settings, where sharing among multiple users may allow for transfer of perspiration, oils, cosmetics, or microbial contamination. Hygienic facial interfaces, removable face cushions, and disposable covers have been developed for facial interfaces, but few solutions have been presented for the surfaces a wearer or facilitator grasps when handling the device.

Existing accessory ecosystems include counterweighted head straps, head-mounted battery packs, and grip extensions that attach to handheld controllers. Such accessories may improve certain aspects of the user experience but may not address the desire for a graspable structure that engages the device itself and allows the wearer to support, manipulate, or hold the device in a stable, ergonomic, and sanitary manner.

Embodiments of the present description provide handle assemblies that mechanically engage a head-mounted electronic spatial computing device and provide a user-graspable structure for supporting, manipulating, augmenting, or interacting with the device. Such handle assemblies may, in various embodiments, allow for one-handed donning and doffing, allow for stable handheld viewing without obstructing sensors of the device, provide a comfortable resting position when the device is not being worn, support sanitary sharing of the device through removable sleeves, accommodate ergonomic preferences of different users through articulation and rotation, integrate handheld controller functionality into a single accessory, and accept supplementary power sources to extend operating time of the device. The various embodiments described herein may be employed alone or in combination, and any feature of any one embodiment may be combined with any feature of any other embodiment except where context indicates otherwise.

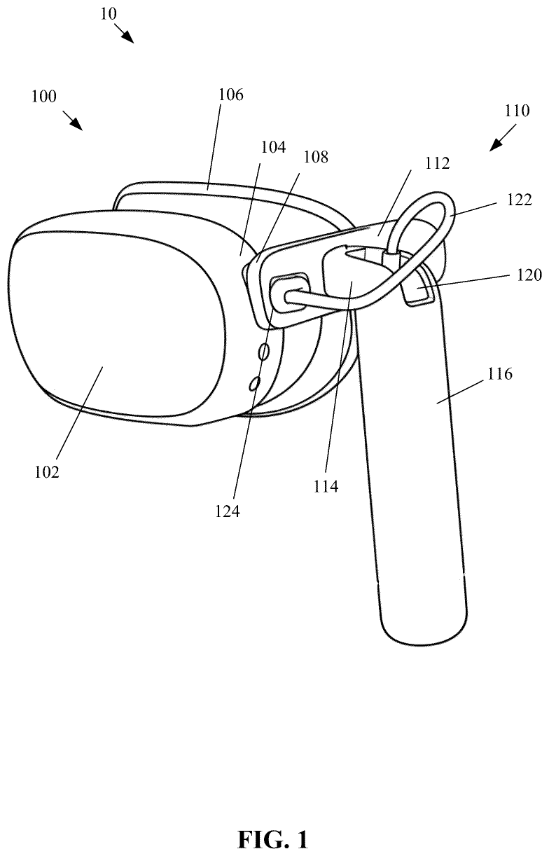

FIG. 1 illustrates a perspective view of a system 10 that includes a head-mounted electronic spatial computing device 100 (also referred to herein as the device 100) with a handle assembly 110 coupled thereto. The device 100 may take the form of a virtual reality headset, an augmented reality headset, a mixed reality headset, a head-mounted display, or another head-wearable electronic device that presents visual or audiovisual content to a wearer. The device 100 may include a front portion 102, a side portion 104, a facial interface 106, and a retention portion 108. The front portion 102 may house or support a forward-facing display assembly and any number of forward-facing sensors (such as cameras, depth sensors, or environmental sensors). The side portion 104 may extend laterally between the front portion 102 and the retention portion 108 and may house or support side-facing sensors, electrical contacts, or other features of the device 100. The facial interface 106 may be configured to bear against the wearer's face and to position the front portion 102 in front of the wearer's eyes, and may include compliant face cushions, light-blocking gaskets, or alignment features. The retention portion 108 may comprise a peripheral structure (such as a strap mount, anchor, recess, ring, channel, or rail) that ordinarily routes or anchors a head strap or other retention member of the device 100 to maintain the device 100 on the wearer's head.

The handle assembly 110 may be coupled with a portion of the device 100, such as the side portion 104, the retention portion 108, an underside, a top, a forward portion, or a rear portion of the device 100, through a fastener, an adhesive, a magnetic interface, a snap-fit interface, a press-fit interface, a threaded interface, a bayonet interface, a clamp, a strap, a coupler that engages the retention portion 108, or any combination thereof, and/or through a port or interface defined by the device 100 (such as an accessory port, a battery port, a charging port, or a data port). The handle assembly 110 may be supplied as an aftermarket accessory configured to be retrofitted onto an already-purchased device 100, or as an integrated component provided with the device 100 as originally manufactured.

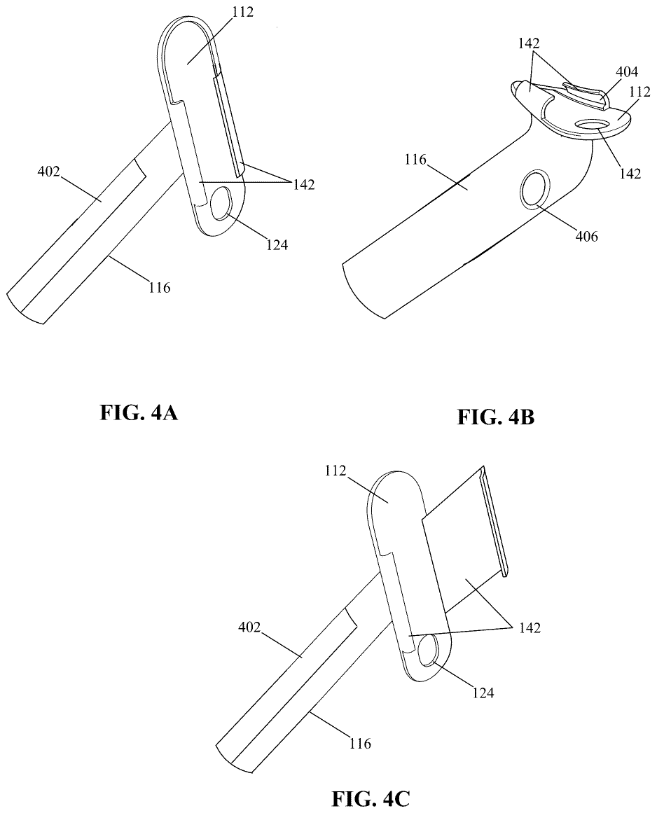

In some embodiments, the handle mount 112 includes or defines a retention feature that mechanically engages a corresponding retention feature of the device 100. Non-limiting examples include a clip, hook, or jaw that engages the retention portion 108 of the device 100 (described in greater detail with reference to FIG. 4); a fastener-receiving feature, such as a threaded bore or pass-through bore, that receives a fastener inserted through the device 100 or through a separate bracket; and a magnetic element that magnetically engages a corresponding magnetic element of the device 100. The particular form of mechanical engagement may be selected based on the configuration of the device 100 and manufacturing, regulatory, and ergonomic considerations.

The handle arm 114 may, in various embodiments, extend along a substantially linear path from the handle mount 112 to the handle body 116, or along a curved, angled, or compound path that places the handle body 116 at a comfortable position relative to the user's hand and arm during use. In some embodiments, the handle arm 114 may include one or more articulated joints that permit the handle body 116 to be repositioned relative to the handle mount 112. The handle arm 114 may have a circular, elliptical, or polygonal cross-section, or any combination thereof. The handle arm 114, together with the handle body 116, may be detachable from the handle mount 112, such that the handle mount 112 may remain coupled with the device 100 while the handle arm 114 and handle body 116 are removed for separate use, storage, or replacement.

The handle body 116 may be sized and shaped to be grasped by an adult human hand, with an outer surface that is substantially cylindrical, frusto-conical, ellipsoidal, prismatic, faceted, or otherwise contoured. The handle body 116 may include one or more contoured surfaces that conform to the curvature of a user's palm or fingers; one or more textured, ribbed, knurled, dimpled, or otherwise non-smooth regions that increase friction between the handle body 116 and the user's hand; and/or one or more low-durometer regions, such as one or more elastomeric overmolds, that conform to the user's grip and provide a comfortable tactile feel.

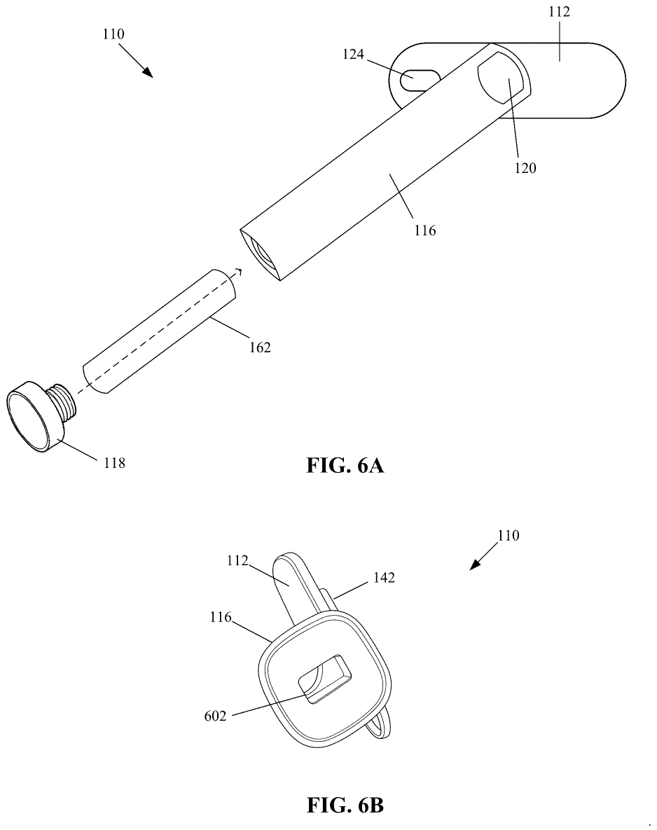

The handle mount 112 may also define an interface port 124. As shown in FIG. 1, the interface port 124 may be configured to align with one or more terminals disposed on the side portion 104 of the device 100 when the handle mount 112 is coupled with the device 100, such that an electrical, optical, or data interface is established between the device 100 and the handle assembly 110 through the interface port 124. The interface port 124 may take the form of a window, opening, recess, or pass-through within the handle mount 112 sized to receive or align with the corresponding terminals of the device 100, or may comprise one or more electrical contacts, magnetic contacts, optical interfaces, or inductive interfaces supported by the handle mount 112. A connection cable 122 may extend from the interface port 124 and may route through a handle connection cavity 120 defined within the handle assembly 110 to one or more electronic components disposed within the handle body 116 (such as a battery, processor, sensor, haptic actuator, wireless radio, or storage device, as further described with reference to FIG. 6). In this manner, the interface port 124 and the connection cable 122 may permit the handle assembly 110 to deliver electrical power, data, or both to the device 100, and to receive electrical power, data, or both from the device 100, while the handle assembly 110 is coupled with the device 100.

The handle connection cavity 120 may extend through one or more of the handle mount 112, the handle arm 114, and the handle body 116 along a longitudinal direction, and may receive and route the connection cable 122 (which may also be referred to as an interconnect cable) and/or one or more additional electrical conductors, optical conductors, fluid conduits, or mechanical linkages between the device 100 and components disposed within or supported by the handle assembly 110. The connection cable 122 may include one or more electrical conductors that transmit electrical power, data signals, or both between the device 100 and components of the handle assembly 110. Examples include power conductors that transmit electrical power between the device 100 and a battery within the handle body 116; data conductors that transmit signals such as universal serial bus (USB), inter-integrated circuit (I2C), serial peripheral interface (SPI), controller area network (CAN), or other digital or analog signals; and coaxial, fiber-optic, or other high-bandwidth signal conductors that transmit image, video, or other high-bandwidth data.

The handle connection cavity 120 may be sealed against ingress of moisture, dust, or other foreign matter through one or more sealing elements (e.g., O-rings, gaskets, lip seals, or potting compounds) disposed at interfaces among the handle mount 112, the handle arm 114, the handle body 116, the handle cap 118, the connection cable 122, and the interface port 124. The handle assembly 110 may be configured to satisfy one or more ingress protection (IP) ratings, such as IP54, IPX4, IP65, IP67, or another suitable rating. Routing the connection cable 122 through the handle connection cavity 120 may permit the handle assembly 110 to deliver electrical power, data, or both to the device 100 without external cabling that may snag, tangle, or impose tension on the device 100 during use, and may permit the handle assembly 110 to incorporate supplementary components while presenting a clean external appearance.

Although FIG. 1 illustrates communication between the device 100 and the handle assembly 110 through the connection cable 122, in additional or alternative embodiments the device 100 and the handle assembly 110 may communicate wirelessly, including while the handle assembly 110 remains coupled with the device 100 through the handle mount 112. For example, the handle assembly 110 may include one or more wireless radios (such as a Bluetooth radio, a Bluetooth Low Energy (BLE) radio, a Wi-Fi radio, an ultra-wideband (UWB) radio, a near-field-communication (NFC) coil, or any combination thereof) that establish wireless data communication with a corresponding wireless interface of the device 100, and/or one or more inductive charging interfaces that transmit electrical power between the device 100 and the handle assembly 110 wirelessly. In such embodiments, the connection cable 122 may be omitted or may carry a subset of the signals exchanged between the device 100 and the handle assembly 110.

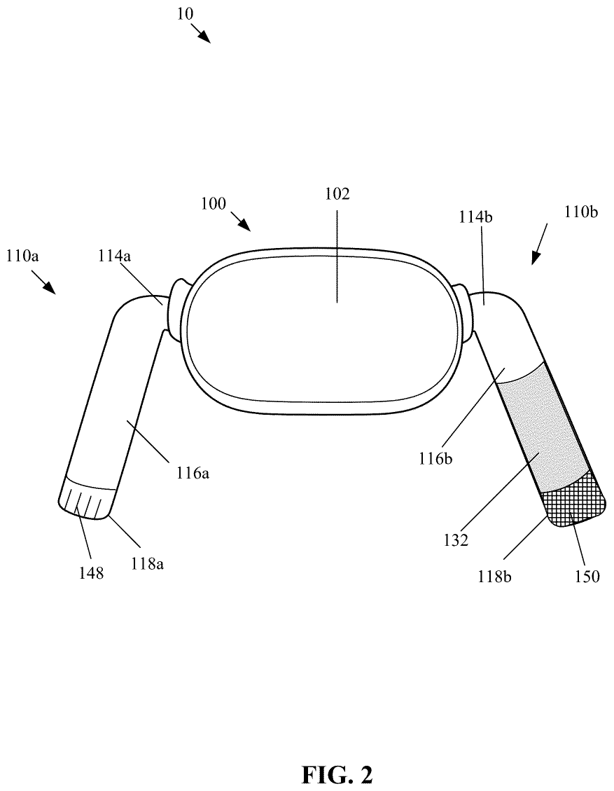

FIG. 2 illustrates a perspective view of a system 20 in which a head-mounted electronic spatial computing device 100 has a first handle assembly 110a coupled with a first lateral side of the device 100 and a second handle assembly 110b coupled with a second lateral side of the device 100 opposite the first lateral side. The first handle assembly 110a may include a first handle arm 114a, a first handle body 116a, and a first handle cap 118a; the second handle assembly 110b may include a second handle arm 114b, a second handle body 116b, and a second handle cap 118b. Each of the first and second handle assemblies 110a, 110b may also include a respective handle mount that engages a corresponding feature of the device 100. The first and second handle assemblies 110a, 110b may share substantially the same construction (and may take the form of any of the handle assembly embodiments described herein) or may differ from one another in shape, size, or function; for example, the first handle assembly 110a may be configured for use by the user's left hand and the second handle assembly 110b for the user's right hand, with corresponding ergonomic contouring on each.

Coupling first and second handle assemblies 110a, 110b with the device 100 may permit the user to support, manipulate, or hold the device 100 with two hands, providing a stable two-handed grasp useful for handheld viewing of immersive content, and may permit the user to operate user-actuatable inputs on either handle assembly without releasing the user's grasp. The first and second handle assemblies 110a, 110b may be in electrical communication with one another through one or more conductors that traverse the device 100, and/or may be coupled to the device 100 through a common mounting bracket, mounting bar, or mounting frame extending across an underside, top, or rear of the device 100, optionally including pass-through cables that route power and/or data between the handle assemblies.

The first and second handle assemblies 110a, 110b may be configured to be folded toward or away from one another (or relative to the device 100) to facilitate stowage and transport. Examples include hinges, pivots, folding joints, or quick-release fittings that permit each handle assembly to be folded against a side of the device 100 or removed entirely when not in use, and telescoping sections that permit each handle assembly to be shortened or lengthened.

The handle assembly 110 may include a handle mount 112, a handle arm 114, a handle body 116, and a handle cap 118. The handle mount 112 is the portion of the handle assembly 110 configured to be coupled with the device 100. The handle arm 114 extends from the handle mount 112 toward the handle body 116 and spaces the handle body 116 from the device 100 by a distance suitable for grasping by the wearer. The handle body 116 is the portion grasped by the user, and may define a grip portion sized to be grasped by a single hand. The handle cap 118 may be coupled with an end of the handle body 116 distal from the handle arm 114 and may close off an interior of the handle body 116 or retain a battery or other component within the handle body 116. These components may be formed as separate parts and assembled together, or two or more may be formed as a unitary structure.

The handle cap 118 may, in some embodiments, be removable from the handle body 116 to permit access to an interior of the handle body 116, and may be threaded, snap-fit, magnetically retained, friction-fit, or otherwise removably coupled to the handle body 116. In other embodiments, the handle cap 118 may be permanently coupled with or integrally formed with the handle body 116. The handle cap 118 may include indicia such as a logo, model identifier, serial number, or regulatory marking, and/or apertures, vents, or grilles (e.g., grilles 148 shown in FIG. 2) that admit air, vent heat, or transmit sound (e.g., speaker 150 shown in FIG. 2). While a handle cap 118 is illustrated in FIG. 1, in other embodiments the handle cap 118 may be replaced by an accessory, such as a saddle, palm rest, body-contact pad, lanyard anchor, or other attachment, as further described herein.

FIG. 2 also illustrates a removable handle sleeve 132 disposed about the second handle body 116b of the second handle assembly 110b. The handle sleeve 132 may take the form of a generally tubular member that surrounds at least a portion of an outer surface of the second handle body 116b, may extend along substantially the full length of the second handle body 116b or only a grip portion thereof, and is sized and shaped to be removably installed on, and removed from, the second handle body 116b by a user. Although the handle sleeve 132 is illustrated in FIG. 2 as disposed about the second handle body 116b, a corresponding handle sleeve 132 may also be disposed about the first handle body 116a (or about the handle body 116 of any other handle assembly described herein), and one or more handle sleeves 132 may be supplied for use with any handle assembly described herein.

In some embodiments, the handle sleeve 132 may be formed of a material that includes, or is treated with, an antimicrobial agent. Examples include a copper-containing material, a copper-alloy-containing material (such as brass or bronze), a silver-containing material, a zinc-containing material, or another antimicrobial-metal-containing material; a polymer impregnated with antimicrobial particles (such as silver ions, copper ions, zinc oxide particles, or titanium dioxide particles); and a polymer treated with an antimicrobial coating (such as a quaternary ammonium coating or a silver-or copper-based coating). The antimicrobial properties of the handle sleeve 132 may inhibit the growth of bacteria, viruses, fungi, and other microorganisms on the surfaces the user grasps, which may be of particular benefit where the device 100 and handle assembly 110 are shared among multiple users.

The handle sleeve 132 may be formed of a flexible or compliant material (such as a silicone, thermoplastic, or polyurethane elastomer, a natural or synthetic rubber, or any combination thereof) that conforms to the user's grip and provides a comfortable tactile feel, or of a rigid or semi-rigid material (such as a thermoplastic, thermoset polymer, metal, alloy, ceramic, composite, or combination thereof). The handle sleeve 132 may be retained on the corresponding handle body 116 through friction-fit, retention features (such as ribs, ridges, lips, or recesses on either component), fasteners, magnetic elements, or any combination thereof, and may be supplied as a single-use disposable accessory or as a reusable accessory cleaned, sterilized, or sanitized between uses.

The handle sleeve 132 may be marked with visual indicia (e.g., color, pattern, logo, alphanumeric identifier, barcode, or quick-response code) that identify the handle sleeve 132 as a single-use article, identify a user, session, or sanitation status, or convey other information, and/or may include one or more indicators (such as thermochromic or chemical-reactive indicators) that change appearance in response to a sanitation procedure. The handle assembly 110 may be supplied as a kit that includes a plurality of handle sleeves 132 differing in color, pattern, material, or antimicrobial treatment, optionally provided in individually sealed packaging that is opened at the time of use to provide a hygienic supply for shared use of the device 100.

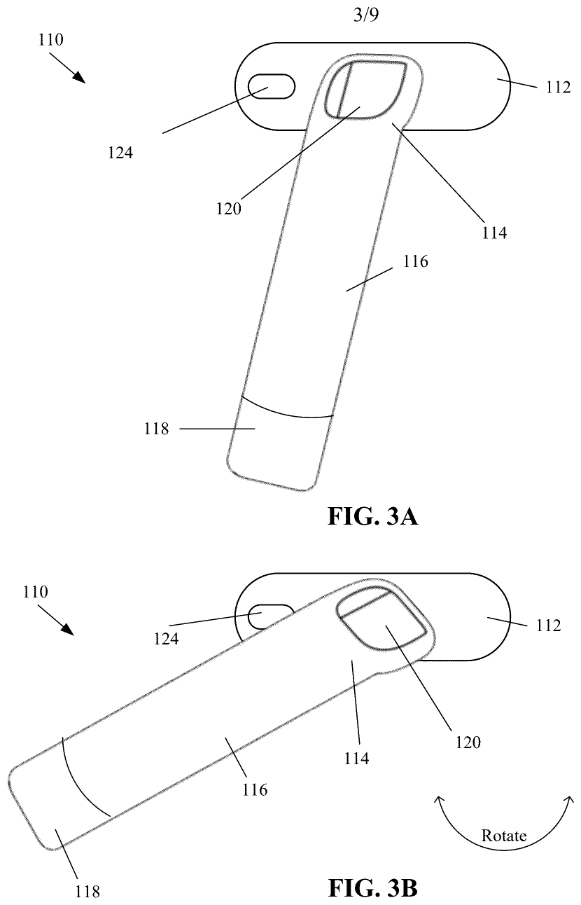

FIGS. 3A and 3B illustrate perspective views of a handle assembly 110 in which the handle arm 114 (and the handle body 116 carried thereby) is rotatable on the handle mount 112 about an axis. FIG. 3A illustrates the handle body 116 in a first angular orientation relative to the handle mount 112, and FIG. 3B illustrates the handle body 116 in a second angular orientation relative to the handle mount 112, with the handle body 116 having been rotated relative to the handle mount 112 about the axis. As shown in FIG. 3B, the rotation arrow indicates the direction of rotation; rotation in the opposite direction is also contemplated.

In some embodiments, the handle arm 114 is rotatably coupled to the handle mount 112 through a rotatable joint, such as a sleeved bearing, a ball bearing, a journal bearing, a pin-and-bushing joint, a flanged collar, or a snap-ring assembly, that permits the handle arm 114 to rotate relative to the handle mount 112 about the axis. The axis may extend along a length of the handle arm 114, transverse thereto, or at any angle therebetween, and may pass through the handle mount 112, the handle connection cavity 120, or any other portion of the handle assembly 110. Where the handle arm 114 is rotatable on the handle mount 112, the handle body 116 carried by the handle arm 114 likewise rotates relative to the handle mount 112 about the axis, changing an angular orientation of the handle body 116 (and accordingly any grip portion thereof) relative to the handle mount 112 and to the device 100.

Rotation may be through a continuous range of angular positions, such as substantially zero to substantially three hundred sixty degrees, substantially zero to substantially one hundred eighty degrees, substantially zero to substantially ninety degrees, any other suitable range, or without limit. In other embodiments, the handle arm 114 is indexable between two or more discrete angular positions defined by detent features such as ball-and-spring detents, magnetic detents, or mechanical pawls, with the discrete positions spaced apart by equal or unequal angular increments.

Permitting rotation of the handle arm 114 (and accordingly the handle body 116) relative to the handle mount 112 may allow the user to reposition the handle body 116 without releasing the user's grasp. For example, a user wearing the device 100 may rotate the handle body 116 to one orientation that is comfortable while standing and another that is comfortable while seated; rotate the handle body 116 when handing the device 100 to or receiving it from another person; or rotate the handle body 116 between a stowed orientation in which it lies substantially flush against the device 100 and a deployed orientation in which it extends away from the device 100.

In some embodiments, the handle assembly 110 may include one or more biasing elements (such as a torsion spring, compression spring, leaf spring, elastomeric element, or magnetic element) that bias the handle arm 114 (and the handle body 116) toward a default angular position relative to the handle mount 112, and/or one or more locking elements (such as a thumb-actuated lever, rotatable collar, push-button, or quarter-turn fastener) that lock the handle arm 114 at a selected angular position relative to the handle mount 112. As shown in FIGS. 3A and 3B, the interface port 124 and the handle connection cavity 120 may be configured such that an electrical, optical, or data connection between the device 100 and the handle body 116 is maintained throughout the range of angular positions; for example, through a slip ring, flexible cable, or wireless link traversing the rotatable joint.

FIGS. 4A-$C illustrate perspective views of a handle assembly 110 in which one or more couplers 142 are carried by the handle mount 112 and are configured to releasably engage the retention portion 108 of the device 100 (described with reference to FIG. 1). As shown in FIGS. 4A-4C, the one or more couplers 142 may extend from a face of the handle mount 112 (such as a face that is positioned adjacent to, or that bears against, the side portion 104 of the device 100) and may be sized and shaped to flex and snap onto, or otherwise mechanically engage, the retention portion 108. The retention portion 108 may comprise a peripheral structure of the device 100 (such as a strap-routing rail, anchor, channel, recess, or ring) that ordinarily routes or anchors a head strap or other retention member of the device 100; by engaging the retention portion 108, the one or more couplers 142 may secure the handle assembly 110 to the device 100 without requiring a dedicated accessory port.

As shown in FIGS. 4A and 4C, the handle body 116 can include one or more compartment doors 402 that may be opened to access the interior cavity of the handle body 116. For example, one or more batteries and/or electronic devices housed within the handle body 116 can be accessible via the one or more compartment doors 402.

The one or more couplers 142 may take the form of one or more cantilever arms, hooks, latches, jaws, snap-fit fingers, or other mechanical engagement features. In one non-limiting example (e.g., shown in FIG. 4A), the one or more couplers 142 comprise first and second cantilever arms that extend in a generally parallel direction from the handle mount 112 and that flex outwardly upon engagement with the retention portion 108 to permit the retention portion 108 to be received between the first and second cantilever arms, and that flex inwardly upon full engagement to retain the retention portion 108 therebetween. In another non-limiting example (e.g., shown in FIG. 4B), the one or more couplers 142 can include one or more integrated rail indents 404 such that the retention portion 108 of the spatial computing device 100 can slide into the integrated rail indents 404; thereby the couplers 142 can at least partially surround and grip the retention portion 108. In another non-limiting example (e.g., shown in FIG. 4C), the couplers 142 can extend away from each other to enable loading of the handle mount 112 adjacent to the retention portion 108. Once the handle mount 112 is in position, the couplers 142 can be brought towards each other to clamp around the retention portion 118 and secure the handle assembly 110 to the spatial computing device 100. For instance, the couplers 142 may be biased (e.g., via spring or similar tension member) towards each other, such that force must be applied to separate the couplers 142 and once the force is relieved the couplers 142 travel toward each other, clamping objects (e.g., the retention portion 108) located there between. In other embodiments, the one or more couplers 142 may take the form of a peg, post, stud, flange, clip, clamp, magnet, or other mechanical engagement feature, and may be configured to engage a corresponding receptacle defined by the device 100 (such as a controller-receiving receptacle, battery-receiving receptacle, accessory port, strap mount, or other feature). The architecture of the one or more couplers 142 illustrated in FIG. 4 is one non-limiting example; other mechanisms for releasably securing the handle assembly 110 to the device 100 are envisaged, as further described herein.

The one or more couplers 142 may selectively retain the handle assembly 110 in engagement with the device 100 through a retention mechanism, such as a spring-loaded latch, sliding lock, rotational lock, magnetic latch, or manual retainer. The retention mechanism may be released through actuation of a release button, lever, tab, slider, or rotational actuator, by twisting the handle assembly 110 relative to the device 100, by pressing a release surface, or by drawing the handle assembly 110 away from the device 100 with sufficient force.

As shown in FIG. 4B, the handle body 116 can also comprise one or more windows 406, which may align with one or more electronics housed within the handle body 116. For example, the one or more windows 406 can enable a user to access one or more buttons and/or switches of electronic devices housed within the handle 116. In another example, the shape of the one or more windows 406 can complement the shape of one or more tracking devices (e.g., GPS trackers). Thereby, the one or more windows can retain (e.g., via friction) a tracking device within the handle body 116. The tracking device (not shown) can enable a user to locate a lost or stolen handle assembly 110.

FIG. 4 also illustrates the interface port 124 carried by the handle mount 112, positioned to align with one or more terminals of the device 100 when the one or more couplers 142 are engaged with the retention portion 108, as described with reference to FIG. 1. The arrangement illustrated in FIG. 4 may permit the handle assembly 110 to be installed on, and removed from, the device 100 by the user without specialized tooling, and may permit the handle assembly 110 to be supplied as an aftermarket accessory compatible with devices that present a retention portion 108 on their lateral, top, bottom, forward, or rear surfaces.

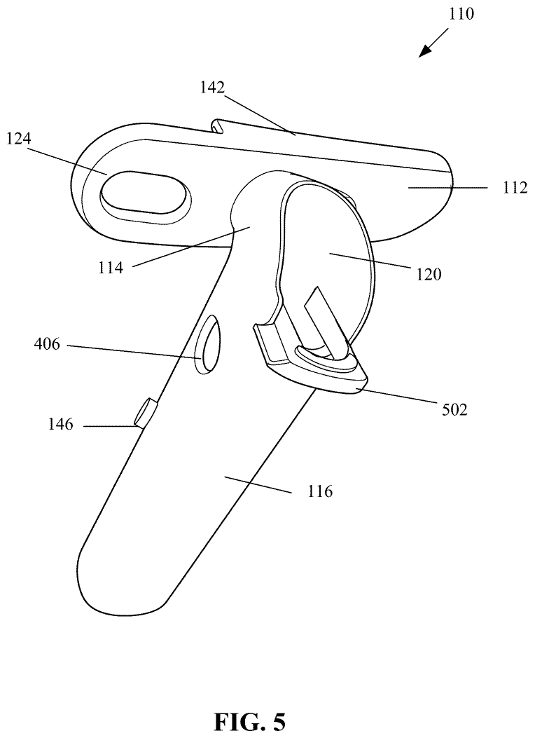

FIG. 5 illustrates a perspective view of a handle assembly 110 in which one or more buttons 146 are disposed on the handle body 116. As shown in FIG. 5, the one or more buttons 146 may be disposed at one or more locations on the handle body 116, on a grip portion thereof, on the handle arm 114, on the handle mount 112, on the handle cap 118, or on any combination thereof, and are configured to receive user inputs (such as actuations, presses, taps, swipes, or holds) from the user during use. The one or more buttons 146 are positioned to be actuated by the user's thumb, index finger, middle finger, or other digit when the user grasps the handle body 116, allowing the user to provide input without releasing the user's grasp.

The one or more buttons 146 may take the form of momentary push-buttons, latching push-buttons, capacitive sensors, resistive sensors, optical sensors, joysticks, thumbsticks, trackpads, triggers, bumpers, paddle switches, or any combination thereof. The handle assembly 110 may include only one button, three, four, five, or more buttons, and the buttons may be supplemented or substituted by other user-actuatable inputs (such as a thumbstick, trackpad, touch-sensitive surface, force-sensitive surface, microphone, or inertial measurement unit) disposed at any of the locations described above.

Inputs received through the one or more buttons 146 (and any additional user-actuatable inputs) may be communicated to the device 100 by the handle assembly 110 through one or more of the connection cable 122 routed through the handle connection cavity 120, the interface port 124, or a wireless interface of the handle assembly 110 (such as a Bluetooth, BLE, Wi-Fi, UWB, NFC, or infrared interface), permitting the handle assembly 110 to function as an input device for the device 100 while remaining coupled with the device 100. In some embodiments, the handle body 116 may house one or more electronic components (such as one or more processors, memory devices, wireless radios, inertial measurement units, haptic actuators, sensors, or energy storage devices) that interpret, process, or relay user inputs received through the first and second buttons 146a, 146b before communicating them to the device 100.

As shown in FIG. 5, the handle assembly 110 can comprise one or more retention clips 502 positioned within the handle body 116. In one or more embodiments, batteries and/or electronic components can be loaded into the handle body 116 via the handle connection cavity 120, and the retention clip 502 can secure such components within the handle body 116. For example, the retention clip 502 can be removeable from the handle body 116 (e.g., can slide into and out of one or more recesses formed within the side walls of the handle body 116). Removing the retention clip 502 creates an unobstructed cavity within the handle body 116 in fluid communication with the handle connection cavity 120. Inserting the retention clip 502 into the handle body 116 can obstruct the cavity within the handle body 116; thereby inhibiting contents within the handle body 116 from exiting via the handle connection cavity 120. In some embodiments, the retention clip 502 can be house a watch battery, such that one or more electronics within the handle body 116 can be powered by the loading the watch battery into the retention clip 502 and inserting the retention clip into the handle body 116.

FIG. 5 also illustrates the coupler 142 (described with reference to FIG. 4) carried by the handle mount 112 and the interface port 124 also carried by the handle mount 112, demonstrating that the user-input features of FIG. 5 may be combined with the coupling and interconnect features described with reference to FIGS. 1 and 4. The architecture of the user-input features illustrated in FIG. 5 is one non-limiting example; other arrangements of buttons or other user-actuatable inputs are envisaged, as further described herein.

FIG. 6A illustrates an exploded perspective view of a handle assembly 110, showing the handle mount 112, the handle body 116, and the handle cap 118 separated from one another along an assembly axis, and an electronic component 162 sized to be received within the handle body 116. The handle assembly 110 may be supplied as a kit of parts that the user assembles or as a pre-assembled article, and the user may disassemble the handle assembly 110 to replace a component, clean an interior surface, access an electronic component, or substitute a component having a different size, shape, color, or material.

In some embodiments, the handle mount 112 and the handle body 116, and likewise the handle body 116 and the handle cap 118, may be coupled to one another through a threaded interface (with corresponding sets of threads on each component), a snap-fit interface (with one or more cantilever fingers, hooks, or barbs on one component received in corresponding recesses on the other), a press-fit interface, a magnetic interface (with one or more magnetic elements on each component), a fastener, a quarter-turn fastener, a bayonet fastener, or another rotational fastener, any combination thereof, or may be integrally formed as a unitary structure. As shown in FIG. 6, the handle cap 118 may be removable from the handle body 116 to permit insertion or removal of the electronic component 162 from a battery compartment or other interior space within the handle body 116.

The electronic component 162 may take the form of a battery, such as a lithium-ion cell, lithium-polymer cell, nickel-metal-hydride cell, nickel-cadmium cell, solid-state cell, primary cell, secondary cell, or any combination thereof, sized to be received within the handle body 116. In additional or alternative embodiments, the electronic component 162 may take the form of, or may further include, one or more circuits, processors, memory devices, wireless radios, inertial measurement units, sensors, haptic actuators, audio transducers, lighting elements, storage devices, or other electronic devices, alone or in any combination, sized to be received within the handle body 116. Where the electronic component 162 is a battery, the battery may supply electrical power to the device 100 through the connection cable 122 and the interface port 124 (described with reference to FIG. 1), to electronic components within the handle assembly 110 itself, to one or more auxiliary devices, or to any combination thereof.

Where the electronic component 162 is a removable battery, the user may carry spare electronic components 162 and swap a depleted battery for a charged one mid-session, allowing for substantially uninterrupted use of the device 100. The handle assembly 110 may include a battery-status indicator (such as one or more LEDs, a numeric or graphical display, or a haptic indicator) that conveys a state of charge of a battery to the user, and/or may communicate the state of charge to the device 100 for rendering within a user interface presented by the device 100. In other embodiments, the electronic component 162 may be a non-removable battery permanently installed in the handle body 116, charged through the interface port 124, through a separate charging interface, or through inductive coupling. Disposing the electronic component 162 within the handle body 116 may distribute the weight of the system 10 between the head and the hand of the user, potentially reducing the perceived weight of the device 100 on the user's head, and may permit the electronic component 162 to be replaced, serviced, or charged independently of the device 100.

Although a handle cap 118 is illustrated in FIG. 6A, in additional or alternative embodiments the handle cap 118 may be replaced by an accessory selected from one or more saddles, palm rests, body-contact pads, lanyard anchors, hand straps, finger loops, wrist supports, charging contacts, indicator lights, or other attachments. The accessory may be supplied as part of a kit with the handle assembly 110 or sold separately, may engage the handle body 116 through any of the same interfaces described above for the handle cap 118, and may permit the user to customize the handle assembly 110 for a particular use case (such as shoulder-bearing support, lanyard tethering, or charging).

In accordance with various embodiments described herein, FIG. 6A is an example of one type of handle assembly 110 architecture envisaged. As shown in FIG. 1, in one or more embodiments the handle assembly 110 does not include a cap 118. As shown in FIGS. 4A and 4C, in one or more embodiments the interior of the body handle 116 can be accessible via one or more compartment doors 402. As shown in FIG. 5, in one or more embodiments the interior of the body handle 116 can be assessable via the handle connection cavity 120, whereby a retention clip 502 can be included to secure contents within the handle body 116. Further, as shown in FIG. 6B, the bottom of the handle body 116, or in some embodiments the handle cap 118, can include one or more opening 602. In one or more embodiments, a connection cable 122 can travel through the one or more openings 602 to connect to one or more electronic components within the handle body 116. In some embodiments, the one or more openings 602 can enable one or more electronic components 162 housed within the handle body 116 to couple to one a charging stand 160. For example, a prong in the connection stand 160 can extend through the one or more openings 602 to couple to the one or more electrical components 162.

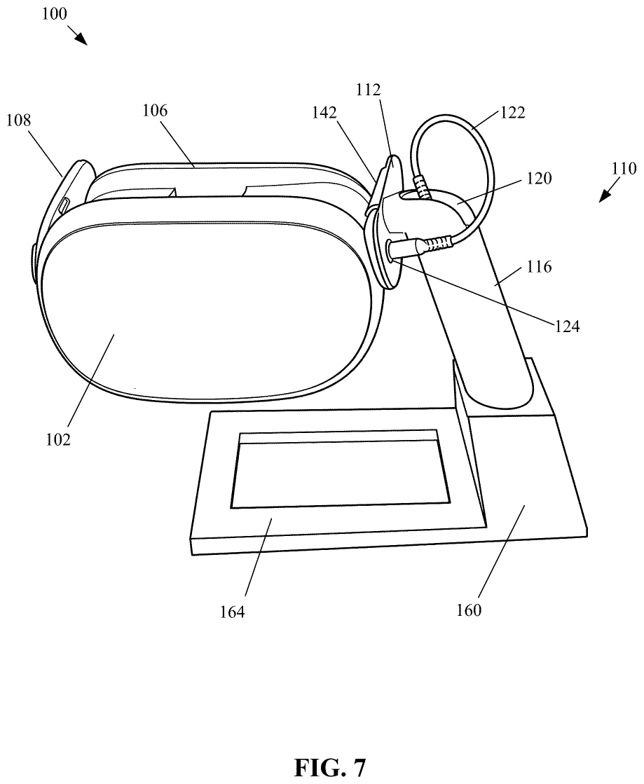

FIG. 7 illustrates a perspective view of a handle assembly 110 engaged with a charging stand 160. The handle assembly 110 may receive electrical power from the charging stand 160 to recharge a battery (such as the electronic component 162 described with reference to FIG. 6) disposed within the handle body 116. As shown in FIG. 7, the charging stand 160 may take the form of a base that supports the handle assembly 110 in a substantially upright, substantially horizontal, or other suitable orientation, and may also be configured to support the device 100, allowing the device 100 to be charged simultaneously with the handle assembly 110.

The charging stand 160 may include one or more conductive contacts that engage corresponding conductive contacts of the handle assembly 110 when the handle assembly 110 is placed on the charging stand 160; for example, charging pins at a base of a charging well that engage charging pads at the handle cap 118 or another portion of the handle assembly 110, and/or a magnetic charging interface engaging a corresponding magnetic charging interface of the handle assembly 110. The charging stand 160 may also include an inductive charging coil that transmits electrical power wirelessly to a corresponding inductive charging coil within the handle assembly 110, conforming to an industry standard (such as the Qi or AirFuel standard) or to a proprietary inductive charging interface.

As shown in FIG. 7, the charging stand 160 can include a base 164 that keeps the stand upright while the handle assembly 110 is loaded into the stand 160. In some embodiments, the base 164 can be orientated such that the stand 160 remains upright even while the spatial computing device 100 is coupled to the handle assembly 110, while the handle assembly 110 is docked with the stand 160. For instance, the base 164 can extend in a direction under the spatial computing device 100 so as to counter-balance the weight of the spatial computing device 100.

Although the charging stand 160 illustrated in FIG. 7 takes the form of a base that supports the handle assembly 110 in a particular orientation, in other embodiments the charging stand 160 may take any of a variety of forms, including a wall-mounted cradle, desk-mounted dock, multi-bay rack, integrated fixture in a vehicle or seat, inductive charging pad, shelf-mounted holder, clamp-mounted holder, or any other structure capable of establishing a charging interface with the handle assembly 110. The charging stand 160 may also be configured to support multiple handle assemblies 110 simultaneously, permitting the charging of multiple handle assemblies 110 at a single station, and to receive any of the handle assembly embodiments described herein.

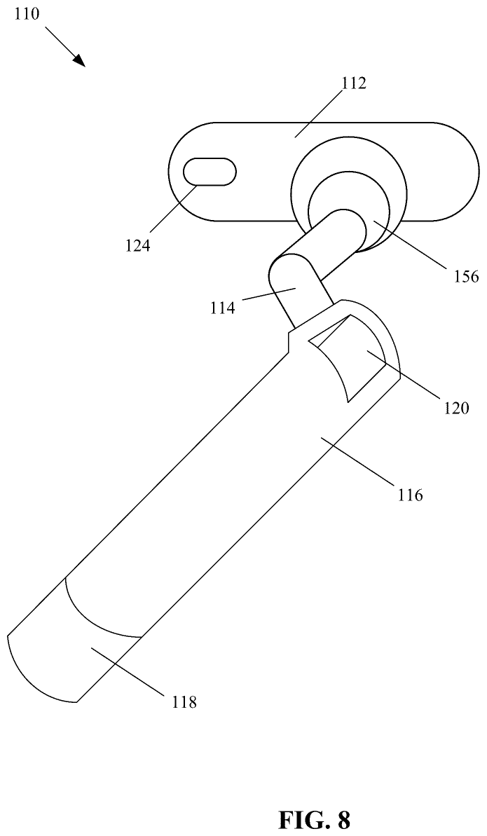

FIG. 8 illustrates a perspective view of a handle assembly 110 that includes the handle mount 112, a handle mounting arm 114 coupled with the handle mount 112, a ball joint 156 disposed between the handle mount 112 and the handle mounting arm 114, and the handle body 116 supported by the handle mounting arm 114, the handle body 116 defining a grip portion sized to be grasped by a user's hand. The ball joint 156 may include a ball 156a and a corresponding socket 156b that retains the ball 156a through a range of angular positions, with the ball 156a supported by, or formed with, one of the handle mount 112 and the handle mounting arm 114 and the socket 156b supported by, or formed with, the other. The ball joint 156 permits the handle mounting arm 114 (and accordingly the handle body 116 supported thereby and any grip portion thereof) to pivot relative to the handle mount 112 about a plurality of non-parallel axes.

The plurality of non-parallel axes may include three substantially mutually orthogonal axes, two non-parallel axes, or any combination of axes that pass through a center of the ball 156a. The range of angular positions about each axis may span, for example, between substantially negative ninety and substantially positive ninety degrees, between substantially negative forty-five and substantially positive forty-five degrees, between substantially negative thirty and substantially positive thirty degrees, or any other suitable range, and may be substantially equal about each axis or may differ among the axes.

The ball joint 156 may be selectively lockable to retain the handle mounting arm 114 (and accordingly the handle body 116) at a selected angular position relative to the handle mount 112. The selective lock may take the form of a friction lock engaged by tightening a collar, knob, lever, thumbscrew, or another actuator; a positive lock engaged through pins, detents, splines, or teeth that arrest motion of the ball 156a relative to the socket 156b; or an electromagnetic, hydraulic, or pneumatic lock. The ball joint 156 may also include one or more friction surfaces between the ball 156a and the socket 156b sufficient to retain the handle mounting arm 114 at any selected angular position absent an applied moment, optionally with adjustability through an adjustment fastener.

Permitting the handle body 116 to pivot relative to the handle mount 112 about a plurality of non-parallel axes may permit the user to position the handle body 116 at a comfortable orientation for the user's hand and arm regardless of the orientation of the device 100; for example, pivoting the handle body 116 to allow the user's wrist to remain in a neutral position while standing or seated, or between an orientation aligned with the user's arm and an orientation transverse thereto. The ball joint 156 may include one or more conductive elements that maintain electrical communication between the device 100 and the handle body 116 through the range of angular positions, such as conductive surfaces on the ball 156a that contact corresponding conductive surfaces of the socket 156b, a flexible or stretchable cable traversing the ball joint 156, and/or a wireless communication interface (such as an NFC coil or a Bluetooth radio) that maintains data communication between the device 100 and the handle body 116.

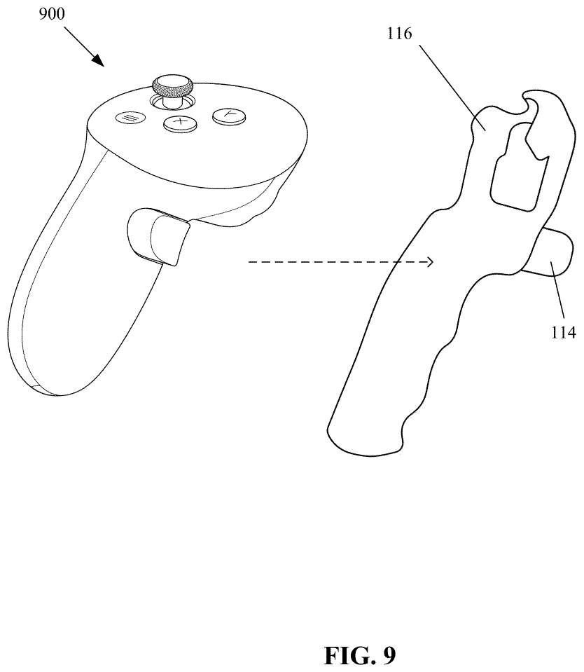

FIG. 9 illustrates a perspective view of a controller adapter embodiment of a handle assembly 110, in which the handle body 116 is shaped to releasably engage a handheld controller 900 of the device 100, and a handle mounting arm 114 is coupled with the handle body 116. As shown in FIG. 9, the handle body 116 may have an outer or inner shape that is at least partially complementary to a corresponding shape of the controller 900, such that the handle body 116 receives, surrounds, partially surrounds, or snaps onto a portion of the controller 900. The handle body 116 may engage the controller 900 without interfering with operation of one or more buttons, triggers, thumbsticks, trackpads, or other user-actuatable inputs of the controller 900, and may leave such inputs accessible to the user during use.

In some embodiments, the handle body 116 in the controller adapter embodiment of FIG. 9 may comprise a cradle, sleeve, partial shell, full shell, clamp, jaw, or other structure that establishes mechanical engagement with the controller 900 through a snap fit, friction fit, magnetic engagement, latch, strap, fastener, or any combination thereof. The handle body 116 may include one or more compliant pads, liners, or grippers that distribute the engagement force, increase friction, and protect the controller 900 from cosmetic damage during installation, removal, or use. The handle body 116 may also define an ergonomic grip portion that may be grasped by the user when the controller 900 is engaged with the handle body 116, and may include finger contours arranged to orient the user's hand in a desired position relative to the controller 900.

FIG. 9 also illustrates the handle mounting arm 114 coupled with the handle body 116. The handle mounting arm 114 may extend from the handle body 116 toward a handle mount 112 (not shown in FIG. 9, but described with reference to FIGS. 1 and 8) that engages the device 100, such that the controller adapter embodiment of the handle assembly 110 is attached to the device 100 through the handle mounting arm 114 and the handle mount 112 in substantially the manner described with reference to other handle assembly embodiments herein. In additional or alternative embodiments, the handle mounting arm 114 may itself include features (such as a coupler 142 or other mechanical engagement feature) configured to engage the device 100 directly, without an intervening handle mount 112.

The handle body 116 in the controller adapter embodiment of FIG. 9 may also define an interface port 124 (visible in FIG. 9 within or adjacent to the handle body 116) positioned to align with one or more terminals of the controller 900 when the controller 900 is engaged with the handle body 116, such that an electrical, optical, or data interface is established between the controller 900 and the handle assembly 110 through the interface port 124. Through the interface port 124, the handle assembly 110 may receive electrical power from the controller 900, supply electrical power to the controller 900 (for example, from a battery within the handle body 116, as described with reference to FIG. 6), exchange data with the controller 900, or any combination thereof. In other embodiments, the handle assembly 110 of FIG. 9 may communicate with the controller 900 wirelessly, including through any of the wireless interfaces described herein.

The controller adapter embodiment of FIG. 9 may permit the handle assembly 110 to retrofit a graspable structure onto an existing handheld controller 900, such that the controller 900 may be supported, manipulated, or augmented through the handle assembly 110 in substantially the same manner as the device 100 itself. By engaging the controller 900 through a complementary handle body 116 and connecting to the device 100 through the handle mounting arm 114, the controller adapter embodiment may permit a user to integrate a controller 900 into the handle-assembly ecosystem described herein, including for purposes of joint charging through a charging stand 160 (as described with reference to FIG. 7), shared communication with the device 100, ergonomic repositioning relative to the device 100, or other functions.

Although the handle body 116 in FIG. 9 is illustrated as having a particular silhouette complementary to a particular controller 900, in other embodiments the handle body 116 may be shaped complementary to other controllers 900 of varying form factors, manufacturers, or generations, and may be supplied as one of a series of differently shaped handle bodies 116 each adapted to a particular controller 900. In further embodiments, the handle body 116 may include one or more reconfigurable, adjustable, or interchangeable inserts, liners, jaws, or pads that adapt the handle body 116 to controllers 900 of different shapes or sizes, permitting a single handle assembly 110 to be used with multiple controllers 900.

In additional embodiments applicable to any of the handle assembly 110 configurations described herein (including those of FIGS. 1, 2, 3A, 3B, 4, 5, 6, and 8), the handle arm 114 (or, in the case of FIG. 8, the handle mounting arm 114) and the handle body 116 may be configured to detach from the handle mount 112, with the handle mount 112 remaining coupled with the device 100 and the handle arm 114 (and handle body 116) being usable separately as a handheld controller. In such embodiments, the handle body 116 may house one or more processors, memory devices, wireless radios, inertial measurement units, haptic actuators, sensors, or energy storage devices that collectively permit the detached handle body 116 (and handle arm 114) to operate as a handheld controller for the device 100. The user may actuate the first button 146a, the second button 146b, or any other user-actuatable input of the handle assembly 110 to provide input to the device 100, while the device 100 is worn by the user, set on a surface, supported by another person, or otherwise positioned independently of the handle assembly 110.

The detached handle assembly 110 (or detached handle arm 114 and handle body 116) may communicate with the device 100 wirelessly when detached, through a Bluetooth radio, a Bluetooth Low Energy (BLE) radio, a Wi-Fi radio, a Zigbee radio, an ultra-wideband (UWB) radio, an infrared transceiver, or any other suitable wireless interface, and may pair with the device 100 automatically upon detachment or through a manual pairing procedure. The detached handle assembly 110 may include spatial-tracking features that permit the device 100 to determine a position, an orientation, or both of the detached handle assembly 110 in space, such as one or more inertial measurement units, visual fiducials (e.g., light-emitting diodes, retroreflective markers, or printed patterns) sensed by cameras of the device 100, ultrasonic transducers, electromagnetic transceivers, or any combination thereof, optionally permitting the device 100 to render a virtual representation of the detached handle assembly 110 within immersive content.

The handle assembly 110 may include a single set of user-actuatable inputs accessible regardless of whether the handle arm 114 and the handle body 116 are engaged with or detached from the handle mount 112, or first and second sets of inputs respectively accessible in the engaged and detached states (optionally sharing one or more common inputs). The handle assembly 110 may be configured to operate as a handheld controller for the device 100 only when detached, both when detached and when engaged, or in different input modes depending on engagement; for example, with actuation of the first button 146a operating as a power button when engaged and as a primary input for an immersive application when detached. The system may include two handle assemblies 110 detachable from the device 100 and usable as a left-hand and a right-hand controller, respectively. Permitting the handle assembly 110 to operate as a handheld controller when detached may permit a single accessory to fulfill multiple functions, reducing the number of accessories the user must acquire, store, transport, and maintain, and may permit access to handheld-controller workflows when a dedicated handheld controller is misplaced, discharged, or otherwise unavailable.

The handle assembly 110 may take any of a variety of overall form factors, including a generally rod-shaped or cylindrical structure that extends from the device 100 along an axis; a generally curved structure that extends from the device 100 along an arc; a generally L-shaped structure with a first segment extending from the device 100 along a first direction and a second segment extending from the first segment along a second direction transverse to the first; or a generally T-shaped, Y-shaped, hook-shaped, pistol-grip-shaped, vertical-grip, or horizontal-grip structure, or any combination thereof.

The handle assembly 110 may have an overall length, measured from the handle mount 112 to a distal end of the grip portion of the handle body 116, of between approximately fifty millimeters and approximately three hundred millimeters, with narrower ranges (e.g., approximately seventy-five to two hundred millimeters, or approximately one hundred to one hundred fifty millimeters) selected based on ergonomic considerations such as the size of the user's hand, the desired distance between the device 100 and the user's hand, and the desired stowed dimensions of the system. The grip portion of the handle body 116 may have a diameter, measured at a circumferential midline, of between approximately ten and approximately fifty millimeters, with narrower ranges (e.g., approximately fifteen to forty millimeters, or approximately twenty to thirty-five millimeters) selected based on ergonomic considerations such as the natural arc of a user's closed fingers around a cylindrical object.

The grip portion of the handle body 116 may have a non-circular cross-sectional shape that promotes ergonomic grasping, such as a generally elliptical shape with a major axis aligned generally transverse to the user's palm; a shape including one or more recesses sized to receive the user's fingers; or a generally tear-drop-, egg-, or lemon-shaped cross-section that provides a defined orientation for the user's grasp. The handle body 116 may include contoured recesses configured to receive a user's thumb, index, middle, ring, or pinky finger. The handle assembly 110 may be substantially symmetrical about a longitudinal axis or substantially asymmetrical (with one side received against the user's palm and the other against the user's fingers), and may include one or more interchangeable handle bodies 116 of different sizes, shapes, or contours that allow the user to select a grip suited to the user's hand size and grasp preferences.

In addition to the coupler 142 engaging the retention portion 108 of the device 100 as described above, the handle mount 112 may mechanically engage the device 100 through other engagement mechanisms. The handle mount 112 may include an adhesive surface (taking the form of a pressure-sensitive, structural, removable, re-stickable, or re-positionable adhesive, optionally supplied with a release liner removed at installation) configured to be adhered to the device 100; a strap (taking the form of a hook-and-loop, buckled, cam-buckle, ratcheting, or elastic strap, optionally with compliant pads or liners) configured to wrap around a portion of the device 100; or a fastener-receiving feature (such as a threaded bore, pass-through bore, captive nut, or insert) configured to receive a fastener (such as a machine screw, thumb screw, quarter-turn fastener, or snap rivet) that secures the handle mount 112 to the device 100, optionally to a corresponding feature provisioned at manufacture.

In some embodiments, the handle mount 112 may include a clamp configured to releasably engage the device 100 through application of a clamping force on existing exterior surfaces of the device 100, allowing the handle mount 112 to engage devices 100 of varying widths, heights, or thicknesses without device-specific tooling or fasteners. The clamp may take the form of a sprung clamp having two opposed jaws biased toward one another by one or more biasing elements (such as springs, elastomers, or magnets); a sliding cradle having two slidable jaws (with one jaw fixed and the other slidable along a track or rail, or both jaws slidable, optionally with a tightening mechanism such as a thumbwheel, knob, or lever); or a screw-tightened or cam-actuated clamp; optionally with compliant pads, liners, or grippers (formed of, e.g., silicone, thermoplastic, or polyurethane elastomer, or natural or synthetic rubber) that distribute the clamping force, increase friction, and protect the device 100 from cosmetic damage. The clamp may be configured for one-handed actuation, for example with a thumb-actuated lever, slider, or button that releases the biasing force, or a pinch grip operable between thumb and fingers. Such a clamping handle mount 112 may permit the handle assembly 110 to be supplied as an accessory compatible with multiple devices 100 from different manufacturers, generations, or form factors, including devices 100 that lack dedicated accessory mounting features.

The electronic component 162 housed within the handle body 116, when configured as a battery, may have a capacity of between approximately one thousand and approximately twenty thousand milliamp-hours, with narrower ranges (e.g., approximately two thousand to ten thousand, or approximately three thousand to six thousand milliamp-hours) selected based on desired operating time, available volume within the handle body 116, weight budget, and cost. The handle assembly 110 may include a power-management circuit that allocates and regulates electrical power among the electronic component 162, the device 100, additional electronic components of the handle assembly 110, any auxiliary devices, and any external source, performing functions such as voltage regulation, current limiting, over-voltage, under-voltage, over-temperature, and short-circuit protection, charge balancing, capacity, time-to-empty, and time-to-full estimation, and authentication, and may communicate with the device 100 through standardized protocols (such as USB-PD, BC1.2, QC, or PPS) or a proprietary protocol.

The handle assembly 110 may include a power input port (such as a USB-C, USB-A, barrel-jack, magnetic, or inductive port) that receives electrical power from an external source (such as a wall adapter, vehicle adapter, portable battery pack, solar panel, or fuel cell). The power input port may be the same as the interface port 124 or a separate port. The handle assembly 110 may also include a power output port (such as a USB-A, USB-C, barrel-jack, magnetic, or inductive output) that supplies electrical power from the electronic component 162 to one or more auxiliary devices (such as a smartphone, tablet, wearable, audio device, or additional handheld controller), allowing the handle assembly 110 to operate as a portable power bank when not engaged with the device 100.

The handle assembly 110 may include one or more wired interfaces (such as USB, serial, parallel, audio, video, or network interfaces, or any combination thereof) that establish wired data communication with the device 100, implemented through conductors of the interconnect cable 122, conductors that traverse the handle mount 112, or conductors routed externally; and/or one or more wireless interfaces (such as Bluetooth, Bluetooth Low Energy (BLE), Wi-Fi, Wi-Fi Direct, Zigbee, Z-Wave, ultra-wideband (UWB), infrared, near-field communication (NFC), or any combination thereof) that establish wireless data communication with the device 100 or auxiliary devices, supplementing the wireless capabilities of the device 100 with additional bandwidth, protocols, range, or any combination thereof.

The handle assembly 110 may include one or more storage devices (such as solid-state drives, secure digital (SD) cards, microSD cards, embedded multimedia cards (eMMC), or universal flash storage (UFS) modules) that store data accessible to the device 100, including user content (such as immersive media files, save files, or user preferences), application content (such as applications or content packs), or system content (such as firmware updates or device drivers); and one or more processing units (such as microcontrollers, microprocessors, digital signal processors, graphics processing units, neural processing units, ASICs, or FPGAs) that supplement, augment, or offload processing tasks from the device 100. The handle assembly 110 may also communicate with cloud services, remote servers, or networked devices through the wireless interfaces independently of the device 100, providing a redundant or supplementary communication path; for example, by communicating telemetry data (such as battery status, usage statistics, or sensor data) to a cloud service, or by receiving firmware updates and updating the firmware of the handle assembly 110, the device 100, or both.

In addition to the first button 146a and the second button 146b described above, the handle assembly 110 may include other user-actuatable input elements such as joysticks, thumbsticks, trackpads, touchpads, touch-sensitive surfaces, force-sensitive surfaces, scroll wheels, jog dials, rotary encoders, capacitive sensors, optical sensors, gesture-recognition sensors, microphones, or voice-recognition systems, disposed at one or more locations on the handle body 116, the handle cap 118, the handle arm 114, the handle mount 112, or any combination thereof. The handle assembly 110 may include one or more haptic actuators (such as eccentric rotating mass (ERM) motors, linear resonant actuators (LRAs), piezoelectric, electrostatic, ultrasonic, or voice-coil actuators, or solenoids) disposed within the handle body 116 or the handle cap 118 that provide haptic feedback corresponding to events occurring within immersive content, and/or one or more thermal feedback elements (such as resistive heaters, Peltier devices, phase-change materials, or fluid-loop heat exchangers) that simulate thermal sensations associated with immersive content.

The handle assembly 110 may include one or more audio transducers (such as speakers, piezoelectric transducers, or bone-conduction transducers) that output audio content associated with immersive content presented by the device 100, notifications, alerts, or spatial audio cues, supplemented or substituted by one or more microphones that capture audio input such as voice commands or environmental sounds. The handle assembly 110 may include one or more cameras or image-capture sensors (such as visible-light, infrared, depth, time-of-flight, structured-light, or event cameras) disposed on the handle body 116 or the handle mount 112 that capture imagery of the user's environment, hand, or grip, providing data informing spatial tracking, gesture recognition, or hand pose estimation. The handle assembly 110 may also include one or more lights, indicators, or displays (such as LEDs, OLEDs, LCDs, electroluminescent panels, or electrophoretic displays) that provide visual feedback to the user, optionally configurable through software running on the device 100.

The handle arm 114 (or, in embodiments employing a handle mounting arm 114 as in FIGS. 8 and 9, the handle mounting arm 114) may take the form of telescoping arms that extend and retract along a longitudinal direction, permitting the user to adjust the spacing between the device 100 and the grip portion of the handle body 116. Such telescoping arms may include two or more nested tubes that slide telescopically relative to one another, with locking mechanisms (such as friction, pin, or cam locks) that retain the handle arm 114 at a selected length. The handle assembly 110 may also be configured to fold or collapse into a stowed configuration that lies substantially flush against the device 100 or occupies a substantially reduced volume relative to a deployed configuration, for example through a folding hinge that folds the handle arm 114 against the device 100, a quick-release fitting that allows the handle assembly 110 to be detached entirely, or a telescoping section that retracts the handle assembly 110 to a substantially reduced length.

The handle assembly 110 may be configured as a modular system including a plurality of interchangeable modules; for example, the handle mount 112 as a first module, the handle arm 114 as a second module, the handle body 116 as a third module, and the handle cap 118 as a fourth module, optionally coupled through standardized mechanical and electrical interfaces that allow substitution without specialized tooling. The handle assembly 110 may also include one or more accessory rails, accessory mounts, or accessory ports that accept supplementary accessories (such as additional electronic components 162, buttons, sensors, lights, audio transducers, storage devices, wireless radios, cameras, lanyards, hand straps, finger loops, wrist supports, palm rests, and fan, cooling, or heating modules), and may include one or more pass-through electrical interfaces that route electrical power, data, or both between the device 100 and accessories engaged with the rails or ports.

Components of the handle assembly 110 may be formed of any of a variety of materials, selected based on weight, strength, cost, manufacturability, aesthetics, and end-of-life disposal. Structural components (such as the handle mount 112, the handle arm 114, the handle body 116, and the handle cap 118) may be formed of polymers (such as ABS, polycarbonate, polyamide, polyoxymethylene, polypropylene, polyethylene, polyetherimide, polyetheretherketone (PEEK), thermoplastic polyurethane (TPU), or thermoplastic elastomer (TPE)); metals or metal alloys (such as aluminum, magnesium, titanium, stainless steel, brass, bronze, or copper); composites (such as carbon-fiber-, glass-fiber-, or basalt-fiber-reinforced polymer); or any combination thereof. Polymer components may be formed by injection molding, blow molding, extrusion, thermoforming, or additive manufacturing (including fused deposition modeling, stereolithography, selective laser sintering, multi-jet fusion, or material jetting); metal components by casting, forging, machining, stamping, drawing, or additive manufacturing (including selective laser melting, electron beam melting, or directed energy deposition); and composite components by hand layup, vacuum infusion, resin transfer molding, compression molding, automated fiber placement or tape laying, or additive manufacturing.

Surfaces of the handle assembly 110 may be treated to provide desired tactile, visual, or functional properties through, without limitation, painting, anodizing, electroplating, powder coating, vapor deposition, polishing, brushing, sand or bead blasting, etching, laser engraving, embossing, debossing, soft-touch coating, hydrophobic or oleophobic coating, antimicrobial coating, ultraviolet-resistant coating, or scratch-resistant coating. Gripping surfaces of the handle body 116 may be treated to provide enhanced friction, while decorative surfaces may be treated to provide a smooth and glossy appearance. The handle assembly 110 may include components formed of recycled, recyclable, biobased, or biodegradable materials, and may be designed to be disassembled at end-of-life for recycling, reuse, or proper disposal of constituent materials, supporting regulatory or voluntary sustainability requirements.

The handle assemblies 110 described herein may be used in a variety of contexts. Non-limiting examples include: consumer entertainment, in which a user wears the device 100 to consume immersive media (such as games, films, music experiences, or interactive narratives) and uses the handle assembly 110 to support, manipulate, or interact with the device 100; professional training, in which a trainee wears the device 100 to engage with simulated environments (such as flight, surgical, industrial-equipment, or first-responder simulators) and uses the handle assembly 110 to handle the device 100 between or during sessions; education, in which a student wears the device 100 to engage with educational content (such as virtual field trips, anatomy lessons, history simulations, or laboratory simulations) and uses the handle assembly 110 to share the device 100 among classmates or support the device 100 during sessions; healthcare, in which a patient or clinician wears the device 100 to engage with therapeutic content (such as exposure therapy, physical therapy, pain-management content, or surgical-planning content) and uses the handle assembly 110 to support, share, or transport the device 100; industrial or computer-aided design, in which a designer or engineer wears the device 100 to engage with design content (such as three-dimensional models, design reviews, or assembly walkthroughs) and uses the handle assembly 110 to support the device 100 during long sessions; and remote collaboration, in which a remote participant wears the device 100 to engage with collaborative content (such as virtual meetings, workspaces, or events) and uses the handle assembly 110 to support the device 100 throughout or swap between attendees.

In retail showrooms, location-based entertainment venues, public installations, museums, theme parks, training centers, and other shared-use environments, the handle assembly 110 may simplify the workflow by which the device 100 is shared among users. For example, a user may approach a kiosk, grasp the handle assembly 110, hold the device 100 against the user's face, consume immersive content, and then return the device 100 to the kiosk by setting it down or handing it back to a facilitator, all while grasping the handle assembly 110. Use of a removable handle sleeve 132, as described with reference to FIG. 2, may further simplify the sharing workflow by providing a sanitary grasping surface for each user. The handle assembly 110 may be supplied as part of a kit including, for example, the handle assembly 110 with a charging stand 160 and one or more spare electronic components 162; with one or more handle sleeves 132 and a sanitation accessory (such as a UV sanitation chamber, wipe dispenser, or sanitizing solution); or with a carrying case, wall-mounting bracket, and charging cable.

One example use case includes public exhibits and museums. The handle assembly 110 can be coupled to a spatial computing device 100, docked and charged within a stand 160, and ready for use. The handle assembly 110 can enable a seamless pick-up-and-explore experience, removing friction for guests. A tethered cable attachment can be integrated into the handle body 116 (e.g., via the cap 118 or the openings 602) to ensure security while maintaining accessibility for continuous public interaction.

Another example use case includes classrooms and group learning. Conventional special computing devices 100 can limit engagement due to setup time and single-user constraints. The handle assembly 110 can transform the experience into a shared, collaborative tool. Students can instantly pick up the system 10, view content, and pass it between peers, enabling fluid group participation and more dynamic learning environments.

Another example use case includes medical and patient communications. In clinical settings, the handle assembly 110 can enable doctors and surgeons to present complex information in an intuitive, visual format without requiring patients to wear head-mounted straps. This supports clearer communication, faster understanding, and more confident decision-making during consultations.

Another example use case includes Aerospace and design review. For aerospace teams and design groups, the handle assembly 110 can enable rapid, collaborative review of 3D models and environments. Instead of individual headset sessions, the teams can quickly share perspectives, iterate on ideas, and make decisions in real time, improving efficiency and alignment across stakeholders.

Another example use case includes real estate and property exploration. Real estate agents can use the handle assembly 110 to provide immersive property walkthroughs without requiring clients to physically visit each location. Prospective buyers can quickly explore multiple homes, compare options, and narrow down their preferences, enabling more decision-making before scheduling in-person visits.

In some embodiments, the handle assembly 110 may be configured such that, when the user grasps the grip portion of the handle body 116 and presses the device 100 against the user's face, a portion of the handle assembly 110 (such as the handle cap 118, a pad, or a saddle) bears against a portion of the user's body, such as the user's shoulder, sternum, upper chest, or lap when seated. Configuring the handle assembly 110 to bear against a portion of the user's body may distribute the weight of the device 100 between the user's hand and body (potentially reducing perceived weight in the hand and muscle fatigue during extended sessions) and may stabilize the device 100 in front of the user's face, reducing motion due to hand tremor or arm fatigue.

The handle assembly 110 may include a body-contact pad or saddle sized and shaped to bear comfortably against a portion of the user's body, formed of a compliant material (such as a foam, gel, or elastomer) and optionally removable from the handle assembly 110 to permit cleaning, replacement, or substitution. The handle assembly 110 may also include a strap, lanyard, or tether that wraps around a portion of the user's body (such as the wrist, forearm, neck, shoulder, or torso) to secure the handle assembly 110 to the user, optionally adjustable in length and releasable from the handle assembly 110.

The handle assembly 110 may include one or more sensors configured to detect that the device 100 is being grasped, handled, or worn by the user, and may, in response, cause the device 100 to transition between operating states. The sensors may take the form of motion sensors (such as accelerometers, gyroscopes, or inertial measurement units), touch sensors (such as capacitive, resistive, optical-proximity, or force-sensitive sensors), or proximity sensors, disposed within the handle body 116, the handle cap 118, the handle arm 114, or the handle mount 112. Upon detection of grasping, lifting, or other handling, the handle assembly 110 may wake the device 100 from a sleep state, transition the device 100 from a low-power to an active state, launch an application, or present a particular user interface; upon detection of release, setting down, or other discontinuation, the handle assembly 110 may transition the device 100 to a sleep or low-power state or suspend an application. Such automatic state transitions may simplify the workflow by which the user engages and disengages with the device 100, particularly in shared-use environments in which the device 100 is repeatedly handed off.

The handle assembly 110 may incorporate one or more tracking modules that permit the device 100, an external tracking system, or a combination thereof to determine a position, an orientation, or both of the handle assembly 110 within a tracked volume. Non-limiting examples include: an optical tracking module (with one or more cameras, infrared sensors, retroreflective markers, light-emitting diodes, or printed fiducials) that determines position or orientation through visual recognition of features in the environment or on the handle assembly 110; a magnetic tracking module (with one or more magnetic-field sources and sensors) that determines position or orientation relative to the magnetic-field sources, which may be effective where line-of-sight optical tracking is obstructed; a radio-frequency (RF) tracking module (with one or more radio transmitters and receivers) that determines position or orientation through received signal strength, time of flight, angle of arrival, or any combination thereof, which may be effective through obstacles that obstruct optical line of sight; an inertial tracking module (with one or more accelerometers, gyroscopes, or magnetometers) that determines position or orientation by dead-reckoning of measured linear acceleration and angular velocity, which may be effective without external tracking infrastructure; and an ultrasonic tracking module (with one or more ultrasonic transmitters and receivers) that determines position or orientation through time of flight, phase, or both. The handle assembly 110 may incorporate any one, any combination, or all of these tracking modalities, providing complementary tracking that may improve overall accuracy and robustness.

The tracking modules may provide tracking with three degrees of freedom (3DOF), six degrees of freedom (6DOF), or any other suitable number of degrees of freedom. When the handle assembly 110 is detached from the device 100, the tracking modules may continue to determine a position or orientation of the handle assembly 110, allowing the handle assembly 110 to function as a tracked handheld controller for the device 100, as further described herein.

In some embodiments, the handle assembly 110 may include one or more biometric sensors configured to identify the user grasping the handle assembly 110. The one or more biometric sensors may, in some examples, take the form of a fingerprint sensor, a palm-print sensor, a vein-pattern sensor, a heart-rate sensor configured to capture a cardiac signature of the user, a galvanic-skin-response sensor, a hand-geometry sensor, or any combination thereof. The one or more biometric sensors may be disposed at one or more locations on the handle assembly 110 that are positioned to be contacted by the user during normal grasping of the grip portion of the handle body 116, such as on a thumb-rest region, on a palm-contact region, on one or more finger-contact regions, on the handle cap 118, or any combination thereof.

Upon identification of the user, the device 100 may configure operating parameters in accordance with the identified user, such as user-specific user-interface configurations, user-specific application defaults, user-specific haptic profiles, user-specific audio profiles, user-specific accessibility settings, user-specific content libraries, or any combination thereof. The biometric identification may also permit the device 100 to enforce access controls, such as restricting access to particular content based on the identity of the user, recording usage attribution by user, or restricting use of the device 100 to authorized users. Such biometric-personalized operation may simplify the workflow by which the device 100 is shared among multiple users in a household, classroom, healthcare environment, or other shared-use setting.

In some embodiments, the handle assembly 110 may include one or more sensors configured to monitor the manner in which the user is grasping or operating the handle assembly 110, and to provide ergonomic feedback to the user. The one or more sensors may take the form of one or more force-sensitive sensors disposed within the grip portion of the handle body 116 that measure the magnitude or distribution of grip forces applied by the user, one or more inertial measurement units that measure orientation or motion of the handle assembly 110, one or more flexure sensors that measure flexion of the user's fingers, or any combination thereof. The handle assembly 110 may analyze the sensor data to detect grip patterns associated with hand fatigue, awkward wrist orientations, prolonged static grasps, or other ergonomic concerns.

In response to detection of an ergonomic concern, the handle assembly 110 may prompt the user to adjust grip, reposition the handle assembly 110, take a break, or otherwise modify the user's interaction with the device 100. Such prompts may take the form of haptic feedback delivered through the haptic actuators described above, audio feedback delivered through the audio transducers described above, visual feedback delivered through the lights described above, or visual or audio feedback presented through the device 100 itself. Ergonomic feedback may support extended sessions, may reduce the risk of repetitive-motion strain, and may permit users to develop usage habits that are comfortable over long use intervals.

In some embodiments, the handle assembly 110 may be a substantially passive structure that includes no battery, no electronic components, no electrical conductors, or any combination thereof. The substantially passive variant may comprise structural components only, such as the handle mount 112, the handle arm 114, the handle body 116, and the handle cap 118, with no electrical or electronic functionality. The substantially passive variant may be supplied at lower cost, with reduced regulatory complexity, with reduced weight, and with simplified manufacturing relative to electronic variants, while still providing the user-graspable structure described herein for supporting and manipulating the device 100.

In some embodiments, the handle assembly 110 may include intermediate variants that include one or more electronic components but omit others. As one non-limiting example, the handle assembly 110 may include an electronic component 162 in the form of a battery and an interface port 124 for delivering supplementary power to the device 100, but may omit user-actuatable inputs, sensors, and tracking modules. As another non-limiting example, the handle assembly 110 may include user-actuatable inputs but may omit a battery and the interface port 124. The variants of the handle assembly 110 may be selected to balance functionality, cost, weight, regulatory complexity, manufacturing complexity, and use-case requirements for a particular product offering.

In some embodiments, the handle assembly 110, when detached from the device 100, may be configured to operate as a remote-control device for one or more devices other than the device 100. As one non-limiting example, the detached handle assembly 110 may be configured to communicate with one or more smart-home devices (such as one or more smart speakers, one or more smart lighting devices, one or more smart thermostats, one or more smart appliances, or any combination thereof) and to control aspects of those devices. As another non-limiting example, the detached handle assembly 110 may be configured to communicate with one or more presentation devices (such as one or more projectors, one or more televisions, one or more displays, or any combination thereof) and to advance slides, control playback, or perform other presentation-control functions. As yet another non-limiting example, the detached handle assembly 110 may be configured to communicate with one or more handheld electronic devices (such as one or more smartphones, one or more tablets, one or more wearables, or any combination thereof) and to control aspects of those devices. The detached handle assembly 110 may communicate with such other devices through any of the wireless interfaces described above, including without limitation Bluetooth, Bluetooth Low Energy, Wi-Fi, Zigbee, Z-Wave, infrared, near-field communication, or any combination thereof.

In some embodiments, configuring the handle assembly 110 to support the device 100 by application of the user's grasp on the grip portion of the handle body 116, rather than through one or more head-encircling straps, may permit the user to wear corrective eyewear (such as eyeglasses) under the device 100 with reduced interference relative to use of one or more head-encircling straps. The handle assembly 110 may allow the user to don and doff the device 100 over corrective eyewear without dislodging the corrective eyewear, repositioning the corrective eyewear, or applying compressive force to the bridge of the user's nose. Such operation may, in some circumstances, improve the experience for users who require corrective eyewear during use of the device 100.

In some embodiments, the handle mount 112 may engage the device 100 at one or more locations that are spaced apart from on-board sensors of the device 100, such that the handle mount 112, the handle arm 114, and the handle body 116 do not overlie or obstruct the on-board sensors of the device 100. The on-board sensors of the device 100 may include one or more cameras, one or more depth sensors, one or more environmental cameras, one or more eye-tracking sensors, one or more inside-out tracking cameras, or any combination thereof, that operate during use of the device 100. By engaging the device 100 at locations that are spaced apart from such sensors, and by configuring the handle body 116 to be held away from the housing of the device 100, the handle assembly 110 may permit the user to support, manipulate, or hold the device 100 without obstructing the field of view of any on-board sensor of the device 100, preserving the spatial-tracking accuracy, environmental-recognition accuracy, and other sensor-dependent performance of the device 100 during use.

In some embodiments, configuring the handle assembly 110 to support the device 100 by application of the user's grasp on the grip portion of the handle body 116 may also permit the user to use the device 100 without applying the device 100 against the user's hair or against the user's applied cosmetics. The user may, in some examples, hold the device 100 in front of the user's face for short-duration use, removing the device 100 between sessions without disturbing the user's hair or transferring cosmetics or oils between the user's face and the device 100. Such operation may, in some circumstances, simplify the user's preparation for use of the device 100 and reduce the time required to clean the device 100 between users.

In some embodiments, the handle assembly 110 may be configured for use in passenger transportation environments. As one non-limiting example, the user may be a passenger in an airplane, a train, an automobile, a bus, a marine vessel, a spacecraft, or another vehicle, and may use the device 100 with the handle assembly 110 to consume immersive content during travel. The grasping configuration provided by the handle assembly 110 may, in some examples, permit the user to don and doff the device 100 quickly when interacting with cabin staff, passing through security checks, exiting the vehicle, or attending to other travel-related events, without manipulating one or more head-encircling straps. The handle assembly 110 may also permit the user to support the device 100 with one hand while securing the user's body within a seat restraint with the other hand.

In some embodiments, the handle assembly 110 may include one or more features adapted for use in passenger-transportation environments, such as one or more retention straps that secure the handle assembly 110 to the user's wrist or to a structural feature of the vehicle, one or more compact form factors that permit the handle assembly 110 to be stowed within a seat-back pocket or carry-on bag, one or more low-profile geometries that fit within constrained passenger-cabin volumes, or any combination thereof.

The architectures, geometries, components, and arrangements depicted in the accompanying drawings are illustrative examples and are not intended to limit the scope of the embodiments described herein. The illustrated architectures convey the underlying principles of operation of the handle assembly and its associated features; the same underlying principles may be implemented with components and arrangements that differ in appearance, configuration, or specific structure from those depicted, while still falling within the scope of the appended claims.

As one non-limiting example, the charging stand 160 depicted in FIG. 7 is shown as a base that supports the handle assembly 110 in a particular orientation; in other embodiments, the charging stand 160 may take any of a variety of forms, including a wall-mounted cradle, desk-mounted dock, multi-bay rack, integrated fixture in a vehicle or seat, inductive charging pad, shelf-mounted holder, clamp-mounted holder, or any other structure capable of establishing a charging interface (whether through conductive contacts, magnetic conductive contacts, inductive coupling, or any combination thereof) with the handle assembly 110. The underlying principle of operation, namely charging an electronic component 162 (such as a battery) of the handle assembly 110 by coupling it with a charging interface of the charging stand 160, is the same regardless of form factor. Similarly, the ball joint 156 depicted in FIG. 8 is shown as a substantially spherical ball in a substantially spherical socket, but the multi-axis pivoting connection may take other forms (such as a U-joint, constant-velocity joint, gimbal, flexure, cardan joint, or a series of orthogonal hinges); the underlying principle, namely permitting the handle body 116 and any grip portion thereof to pivot relative to the handle mount 112 about a plurality of non-parallel axes, is the same regardless of the specific structure.

As further non-limiting examples, the handle mount 112 depicted in FIG. 1 may engage any region of the device 100 that presents a suitable structural feature (including an underside, top, forward, rear, left, or right side), and the handle body 116 depicted in FIGS. 1, 2, 3A, 3B, 4, 5, 6, 7, 8, and 9 may take any of a variety of contours and lengths provided it presents a graspable structure or otherwise engages the device 100 or a controller 900; the underlying principles, namely mechanically engaging the device 100 to provide a user-graspable structure, and providing a graspable structure that permits the user to support and manipulate the device 100 or a controller 900 associated with the device 100, are the same regardless of the particular region engaged or the specific contour or length. Accordingly, the depictions of FIGS. 1, 2, 3A, 3B, 4, 5, 6, 7, 8, and 9 should be understood to convey representative configurations; the embodiments encompass any structure, geometry, or arrangement that operates in accordance with the underlying principles described herein and that satisfies the limitations of the appended claims.

As used herein, the singular forms “a,” “an,” and “the” are intended to include the plural forms unless the context clearly indicates otherwise. The terms “comprises,” “comprising,” “includes,” “including,” “has,” and “having” specify the presence of stated features, integers, steps, operations, elements, or components, but do not preclude the presence or addition of one or more other features, integers, steps, operations, elements, components, or groups thereof. The term “couple” and its variants are used in their broadest sense to refer to any direct or indirect connection or interaction between two or more components, whether mechanical, electrical, magnetic, optical, fluidic, thermal, or otherwise; “coupled” components need not be in direct physical contact and may be coupled through one or more intermediate components.

The term “configured to” indicates that the recited element is structured, arranged, sized, shaped, or otherwise adapted to perform the recited function, but does not imply that the recited element is the only element capable of performing the recited function nor that it is required to perform the function at all times. The term “based on” is intended to mean “based at least in part on” and does not preclude additional bases. The terms “approximately,” “substantially,” and “about,” when applied to a numerical value or geometric relationship, indicate that minor variations from the recited value or relationship are within the scope of the term, including variations attributable to manufacturing tolerances, measurement uncertainty, environmental conditions, and other factors that ordinarily skilled artisans recognize as appropriate.

The term “handle assembly” refers broadly to a structure that mechanically engages a head-mounted electronic spatial computing device and provides a user-graspable feature for manipulating, supporting, or interacting with the device, and is not limited to any particular geometry, material, or function. The term “grip portion” refers to the portion of a handle assembly configured to be grasped by a user; the grip portion need not be a separate component and may be integrally formed with another component (such as a handle body or a handle arm).

The foregoing descriptions of specific embodiments are presented for purposes of illustration and description, and are not intended to be exhaustive or to limit the embodiments to the precise forms disclosed; many modifications and variations are possible in view of the above teachings. Any feature described with respect to one embodiment may be incorporated into, combined with, or substituted for a feature described with respect to any other embodiment, except where context dictates otherwise. The structures, dimensions, materials, manufacturing processes, and functional relationships described herein are illustrative and may be modified, supplemented, or replaced as design considerations dictate. The use of relative terms such as “front,” “rear,” “top,” “bottom,” “side,” “upper,” “lower,” “inner,” “outer,” “vertical,” “horizontal,” “left,” and “right” is for convenience of description and does not require a particular orientation in space. The described embodiments may be combined in various combinations and sub-combinations, and this description encompasses all such combinations and sub-combinations as if each had been individually described. Modifications, additions, deletions, and substitutions to the disclosed embodiments are within the scope of the appended claims.

The handle assembly may include one or more identification features (such as a serial number, unique device identifier, model identifier, authentication token, cryptographic key, near-field-communication tag, barcode, or quick-response code) that permit the device to identify the handle assembly and configure operating parameters accordingly (such as button mappings, haptic profiles, audio profiles, or charging profiles). The handle assembly may include one or more security features, such as a tamper-evident seal that visibly indicates opening or disassembly; a kill switch, lock, or authentication mechanism that disables the handle assembly absent valid authentication; or a tracking module (such as a Bluetooth, Wi-Fi, cellular, or GPS tracker) that permits the user to locate a misplaced handle assembly.

The handle assembly may include one or more accessibility features, such as button caps that are oversized, contrasting in color, or marked with raised indicia for easier identification and operation by users with limited vision; button-actuation mechanisms requiring less force, longer travel, or shorter travel for users with limited hand strength or dexterity; or voice-, gesture-, or breath-activated input modalities that supplement or substitute for button-based inputs. The handle assembly may also be reconfigurable between left-handed and right-handed configurations; for example, with user-actuatable inputs accessible by either thumb when held in the corresponding hand, software-reassignable input mappings, or a removable or rotatable cover, palm rest, or finger loop. The handle assembly may be supplied with aesthetic options (such as color, texture, finish, or pattern options) selected at purchase or customized after purchase through removable covers, sleeves, decals, paints, or other aftermarket modifications.

The handle assembly may include one or more software-defined modes that adjust the function of the handle assembly based on context; for example, a “support mode” in which the handle assembly principally functions as a structural support for the device with reduced or disabled inputs; a “controller mode” in which the handle assembly principally functions as a handheld controller with active inputs; or a “charging mode” in which the handle assembly principally functions as a power source with reduced or disabled functionality of other components. The mode may be selected by the user through a menu on the device or automatically based on detected context. The handle assembly may also include network-connected features that permit interaction with cloud services or remote devices, such as a software-update interface that retrieves firmware updates and installs them on the handle assembly, the device, or both; a telemetry interface that reports usage, sensor, or diagnostic data to a cloud service; and/or a remote-control interface that permits a remote operator to control aspects of the handle assembly (such as illumination, sound, or haptic output) in connection with a remote experience.

Two or more handle assemblies may be configured to communicate with one another, either directly or through the device, exchanging data such as orientation, button-state, or sensor readings. For example, two handle assemblies engaged with the device on opposite lateral sides may share state information through a wired pass-through cable traversing the device, and two handle assemblies detached from the device and used as left-hand and right-hand controllers may exchange state information through wireless communication.

Various embodiments of the handle assemblies described herein may be operated as accessories aftermarket-installable on existing head-mounted electronic spatial computing devices, configured to engage existing structural features (such as straps, strap mounts, accessory ports, charging ports, headphone jacks, controller-receiving receptacles, or battery compartments) and optionally supplied with adapters, brackets, shims, or fasteners that facilitate engagement with devices of varying form factors. Other embodiments may be supplied as integrated components provided with the device 100 as originally manufactured, designed in coordination with the device 100 to engage purpose-built features (such as accessory mounts, electrical contacts, sensor windows, or antenna pass-throughs), and may be permanently installed or removable and replaceable by the user. The device 100 may, in coordination, include one or more dedicated accessory features (such as accessory ports, accessory rails, mounting bosses, electrical contacts, or communication interfaces) configured to authenticate the handle assembly, exchange data, or deliver or accept electrical power. Embodiments may be configured for use with a particular generation, model, or family of devices or with multiple generations, models, or families, with compatibility informed by device design, accessory ecosystem, regulatory environment, and commercial strategy.

What is claimed is:

1. A handle assembly comprising:
a handle mount comprising a device coupling interface adapted to releasably engage a complementary structure of an electronic spatial computing device;
a handle arm rotatably coupled to the handle mount; and
a handle body coupled to the handle arm, the handle body defining a grip portion sized to be grasped by a user's hand, wherein the handle arm is rotatable on the handle mount to change an angular orientation of the handle body relative to the device coupling interface.

2. The handle assembly of claim 1, wherein the device coupling interface comprises at least one of a snap-on connection, a mechanical grip, an elastic band, a spring loaded member, a tension member, an adhesive, a latch, a coupler, or a sleeve.

3. The handle assembly of claim 1, wherein the handle mount defines an interface port configured to receive a connector for providing power, data, or both power and data between the handle assembly and the electronic spatial computing device.

4. The handle assembly of claim 3, further comprising a connection cable positioned within the interface port, wherein the handle arm defines a handle connection cavity configured to receive or route at least a portion of the connection cable.

5. The handle assembly of claim 3, wherein the handle body houses a battery accessible via the handle connection cavity.

6. The handle assembly of claim 5, wherein the handle body comprises a removable handle cap configured to provide access to a battery compartment within the handle body.

7. The handle assembly of claim 5, further comprising a charging stand including a receptacle dimensioned to receive the handle body and a charging interface positioned to charge the battery while the handle body is received in the receptacle.

8. The handle assembly of claim 1, wherein the handle body comprises one or more user input controls positioned to be actuated while the grip portion is grasped by the user.

9. The handle assembly of claim 1, wherein the handle body comprises at least one of a haptic actuator, a motion sensor, a touch sensor, a microphone, a biometric sensor, or a tracking module.

10. A ball joint handle assembly, comprising:
a handle mount comprising a device coupling interface adapted to engage an electronic spatial computing device;
a handle mounting arm coupled to the handle mount;
a handle body coupled to the handle mounting arm, the handle body defining a grip portion sized to be grasped by a user's hand; and
a ball joint positioned at a connection between the handle mount and the handle mounting arm, wherein the ball joint is configured to permit the handle arm to rotate on the handle mount and to pivot relative to the handle mount about at least two nonparallel axes.

11. The ball joint handle assembly of claim 10, wherein the ball joint comprises a ball member received in a socket of the handle mount.

12. The ball joint handle assembly of claim 10, further comprising a retention mechanism configured to selectively maintain the handle arm at a selected angular position relative to the handle mount.

13. The ball joint handle assembly of claim 12, wherein the retention mechanism comprises at least one of a friction element, a tensioning element, a latch, a threaded fastener, or a clamp.

14. The ball joint handle assembly of claim 10, wherein the handle mount comprises an interface port positioned laterally of the ball joint.

15. The ball joint handle assembly of claim 10, wherein the handle body comprises a modular grip component configured to be exchanged with another grip component having a different contour, size, handedness, or control arrangement.

16. A controller adapter handle assembly, comprising:
a handle mount comprising a coupling interface adapted to releasably secure an electronic spatial computing device; and
a handle body having a shape complementary to the silhouette of a handheld controller of the spatial computing device, the handle body defining an ergonomic grip portion; and
a handle arm extending from the handle body and removably coupled to the handle mount, wherein the handle arm is rotatable on the handle mount to adjust a position of the handle body relative to the handle mount.

17. The controller adapter handle assembly of claim 16, wherein the controller coupling interface comprises at least one of a cradle, a clamp, opposing retaining arms, a latch, or a snap fit structure.

18. The controller adapter handle assembly of claim 16, wherein the handle body comprises finger contours arranged to orient the user's hand relative to the handheld controller.

19. The controller adapter handle assembly of claim 16, wherein the handle mount comprises an interface port positioned to enable electrical coupling the handle body to the handheld controller.

20. The controller adapter handle assembly of claim 16, wherein the handle body comprises at least one of a tracking module, a wireless communication module, a haptic actuator, or a battery such that the controller adapter handle assembly is operable as an input accessory when the handheld controller is secured to the controller coupling interface.
